(19) United States
(12) Patent Application Publication
(10) Pub. No.: US 2009/0173112 A1
(43) Pub. Date: Jul. 9, 2009

(54) Enhanced tracing of lost luggage using lock having coated housing and binary display

(76) Inventor: David Tropp, Brooklyn, NY (US)

Correspondence Address: Steven Horowitz;Counselor At Law, Suite 700, 295 Madison Avenue, New York, NY, 10017, US

(21) Appl. No.: 12/006,731

(22) Filed: Jan. 4, 2008

(51) Int. Cl. A45C 13/18; E05B 65/52; G06Q 90/00

(52) U.S. Cl. 70/69; 705/1

(57) ABSTRACT

A method of tracing lost airline luggage locked by a special lock after the airline luggage was checked and screened by a luggage screening entity comprises providing the lock openable only by key and master key and having a metal body surrounded by a flexible rubber coating to prevent breakage. The housing includes a unique serial number and tracing information and a re-settable binary display indicating whether the luggage screening entity used the master key to open the lock. Consumers are told to register the lock with the tracing entity and check in the luggage without exposing passenger contact information, and that a finder of the luggage, if lost, can use the tracing information and serial number to return the luggage for a reward whereupon the passenger can from the binary display determine whether the luggage screening entity opened the luggage.

### BACKGROUND OF THE INVENTION

The field of this invention is methods and apparatuses used for finding checked baggage that has been lost, and more particularly, improved methods of tracing such lost baggage and special locks therefore.

In accordance with the current practice in airport security, a special procedure is used for screening luggage at airports if the luggage has a “special lock” alerting the airport security screening entity that the airport security screening entity has the master key and has agreed previously to open up the lock with the master key rather than break into the luggage. In this context, “special locks” refers to the locks that have associated identifying indicia that alerts the airport security screening entity that it has the master key pursuant to the procedure outlined in detail in U.S. Pat. Nos. 7,036,728 and 7,021,537 to Applicant Tropp. In the context of the special luggage locks described above that alert the airport security screening entity to use a master key previously provided to it, it is also known to have binary displays on these “special locks” that indicate whether or not a piece of luggage that is retrieved in the ordinary course by the passenger has been opened by the airport security screening entity using the master key during inspection.

An article in USA Today dated Sep. 10, 2004 and entitled “TSA to reimburse 15,000 airline passengers for bag claims” notes that after the U.S. Transportation Security Administration (“TSA”) began inspecting checked bags at the end of 2002, it created a “new chain of custody for checked bags that goes from the airline to the TSA back to the airline” whereas before the new airport security screening entity security procedures were enacted the airlines had sole responsibility for baggage once it was checked. According to the article, after enactment of the new security procedures passenger complaints about lost, stolen or damaged possessions increased dramatically to the point where “many people don't even bother to make claims anymore” but rather throw up their hands. The article also reports that two dozen baggage screeners “have been charged with stealing from checked bags”.

If the luggage is lost, the luggage or its contents may be lost or damaged when returned. When the luggage is returned, the passenger is upset and does not know who in the chain of custody is responsible for any damage to the luggage—the airline or the airport security screening entity. The passenger may be keenly seeking information identifying liable parties. Instead, the passenger, unable to find an accountable party, is typically frustrated and feels helpless since the TSA and the airline may very well not even agree on who is responsbible. Furthermore, since the case is one in which the luggage has been taken off its regular routine, was lost and has been damaged, the lock may not still be on the luggage since the luggage and metal luggage lock have been opened and knocked around so many times. The metal lock may simply have broken and fallen off.

There is a need to help airline passengers who have lost their airline luggage to retrieve this luggage, and, if this luggage has been damaged, to identify a party who can be held accountable for such damage.

Out of fear of losing their luggage passengers are encouraged to and typically do provide contact information on tags and the like attached to their luggage. While standing on line to check in baggage at the airport, or even before the actual check-in at the airport, as well as once the luggage has been checked in, passengers risk exposing their contact information to others. Ordinary passengers may wish to keep their travel plans confidential for security or other reasons. For example, an unscrupulous baggage screener could potentially act on information that the traveler is out of town. In addition, businesspeople may wish to keep their company's business trip confidential, even from airline personnel. This is even more so today when someone who receives information that a traveler will be out of town can with one click on a computer obtain that traveler's address and telephone number.

The reasons for confidentiality of the contact information of the passenger or the passenger's company are endless but in practice they often give way to the need to enhance the chances of having the luggage returned to the rightful owner expeditiously, if lost. While on the one hand many passengers may not wish to reveal their identity or the identity of their business in connection with a particular business trip, they may on the other hand desire to facilitate the process by which finders of their lost luggage can expeditiously identify the owner of the luggage and return the lost luggage to such owner.

One known attempt to address the confidentiality concern is a luggage lock with a retractable ID card so that the contact information on the card is not visible until you take the action of retracting the card. Although this may reduce visual accessibility of contact information, the contact information is still easily accessible to anyone within a second by retracting the card without the passenger's knowledge or consent. Although the retractable card may be made lockable, locking it would seem to defeat the whole purpose of allowing finders of the luggage to easily return the luggage to the rightful owner. Accordingly, there is a need to overcome these drawbacks and improve over the prior art.

### SUMMARY OF THE PRESENT INVENTION

In one aspect of the present invention, there is presented a special lock suitable for use in locking individual pieces of an airline passenger's luggage, comprising: a key mechanism that allows the special lock to be opened by a key and by a master key, the special lock having no other mechanism designed for opening the special lock, a housing of the special lock having on a first side thereof a unique serial number of the special lock and having tracing information enabling a finder of the luggage to contact a tracing entity from anywhere in the world, the special lock having identifying indicia other than the serial number alerting the luggage screening entity that the luggage screening entity has the master key and does not need to break into the luggage, the housing having on a second side thereof a window through which a display is visible, the display changing from a first visible state to a second visible state when the luggage screening entity uses the master key to open the special lock, the display capable of being re-set from the second visible state to the first visible state when the key is used to open the special lock, the housing comprising a metal body surrounded by a flexible rubber coating that prevents the special lock from breaking if the special lock collides on multiple occasions with hard surfaces.

In a further aspect of the present invention, there is presented a method of tracing lost airline luggage locked by a special lock after the airline luggage was checked and screened by a luggage screening entity, the special lock having identifying indicia alerting the luggage screening entity that the special lock can be opened with a master key in the luggage screening entity's possession, rather than by breaking the lock, the method comprising: making available to consumers the special lock for use in locking individual pieces of an airline passenger's luggage wherein the special lock includes a key mechanism allowing the special lock to be opened by a key held by the airline passenger and by a master key held by a luggage screening entity, the special lock having no other mechanism designed for opening the special lock, the special lock having a housing comprising a metal body encased in a flexible coating that prevents the special lock from breaking if the special lock collides on multiple occasions with hard surfaces, the housing containing on a first side thereof a unique serial number of the special lock and having tracing information enabling a finder of the luggage to contact a tracing entity from anywhere in the world, the housing having a window through which a display is visible, the display changing from a first visible state to a second visible state when the luggage screening entity uses the master key to open the special lock, the display capable of being re-set from the second visible state to the first visible state when the key is used to open the special lock; and conveying to consumers the information that (i) the special lock can be registered with the tracing entity, (ii) they can carry and check in the luggage without revealing passenger contact information to someone located at or near the luggage; and that (iii) the luggage, if lost, can be returned to the airline passenger using the tracing information and serial number and that upon return of the luggage the airline passenger can determine from the display whether the luggage screening entity opened the luggage.

In another aspect of the present invention, there is presented a method of tracing lost airline luggage locked by a special lock after the airline luggage was checked and screened by a luggage screening entity, the special lock having identifying indicia alerting the luggage screening entity that the special lock can be opened with a master key in the luggage screening entity's possession, rather than by breaking the lock, the method comprising: making available to consumers the special lock for use in locking individual pieces of an airline passenger's luggage wherein the special lock includes a key mechanism allowing the special lock to be opened by a key held by the airline passenger and by a master key held by a luggage screening entity, the special lock having a housing comprising a metal body encased in a flexible coating that prevents the special lock from breaking if the special lock collides on multiple occasions with hard surfaces, the housing containing on a first side thereof a unique serial number of the special lock and having tracing information enabling a finder of the luggage to contact a tracing entity from anywhere in the world, the housing having a window through which a binary display is visible, the binary display changing from a first visible state to a second visible state when the luggage screening entity uses the master key to open the special lock, the binary display capable of being re-set from the second visible state to the first visible state when the key is used to open the special lock; and conveying to consumers the information that (i) the special lock can be registered with the tracing entity, (ii) they can carry and check in the luggage without revealing passenger contact information to someone located at or near the luggage; and that (iii) the luggage, if lost, can be returned to the airline passenger using the tracing information and serial number and that upon return of the luggage the airline passenger can determine from the binary display whether the luggage screening entity opened the luggage.

These and other features, aspects and advantages of the present invention will become better understood with reference to the following drawings, descriptions and claims.

### BRIEF DESCRIPTION OF THE DRAWINGS

FIG. 1A is a front view of the special lock used in the method of the present invention with the binary display indicating that the lock was not opened;

FIG. 1B is a front view of the special lock of FIG. 1A with the binary display indicating that the lock was opened by the luggage screening entity and including a partially broken away cross-sectional view of the housing of the special lock of FIG. 1A;

FIG. 2 is a rear view of the lock of FIG. 1;

FIG. 3 is left side view of the lock of FIG. 1;

FIG. 4 is a right side view of the lock of FIG. 1;

FIG. 5 is a bottom view of the lock of FIG. 1;

FIG. 6 is a top view of the lock of FIG. 1;

FIG. 7 is a rear perspective view of the lock of FIG. 1; and

FIG. 8 is a flow chart showing a method of the present invention.

### DETAILED DESCRIPTION OF THE INVENTION

The following detailed description is of the best currently contemplated modes of carrying out the invention. The description is not to be taken in a limiting sense, but is made merely for the purpose of illustrating the general principles of the invention, since the scope of the invention is best defined by the appended claims.

The present invention generally provides a special lock that may be used in locking individual pieces of an airline passenger's luggage and which may contain an identifying indicia alerts the luggage screening entity that it has the master key and that the special lock is among those that the luggage screening entity has agreed to open to inspect contents of the luggage using the master key. The lock may also have a protective housing to preserve it in the event the luggage is lost or damaged. The lock may have tracing information and a color binary display to help the passenger retrieve the luggage and lock and obtain information as to whether the airport security screening entity has responsibility for the damaged luggage. The method includes making available to consumers such a special lock, and conveying to consumers the information registering the special lock with a tracing company, applying the lock to luggage and checking the luggage in at the airport so that the luggage can be screened by the luggage screening entity using the master key for special locks and so that if the luggage is lost a finder can contact the tracing company and return the luggage thereby allowing the passenger to observe the binary display and determine whether the luggage screening entity is potentially responsible for any damage to the luggage and/or special lock or for their temporary loss.

In contrast to the prior art, if the luggage is lost, the special lock and method of the present invention may assure that the lock does not break and stays attached to the luggage. In further contrast to the prior art, which make use of combination locks where the risk of forgetting the combination or jamming while setting combination is always present, the lock and method of the present invention may employ a lock openable only by a key and master key. In addition, in contrast to the prior art, which makes use of a binary display on a lock, the present invention may integrate the binary display determining whether the luggage screening entity opened the lost luggage with tracing information and a unique serial number to help a finder return the luggage and allow the passenger to narrow down the responsible party for any damage. In further contrast to the prior art, wherein contact information on the luggage is accessible to others, the method of the present invention allows a passenger to check in discretely and feel secure about retrieving his or her luggage and lock, if lost, without exposing confidential information to others at the airport. In further contrast to the prior art, the method of the present invention may allow lost luggage to be returned in a manner that educates the passenger as to what happened to the lost luggage and that affixes potential responsibility for any damage to the luggage.

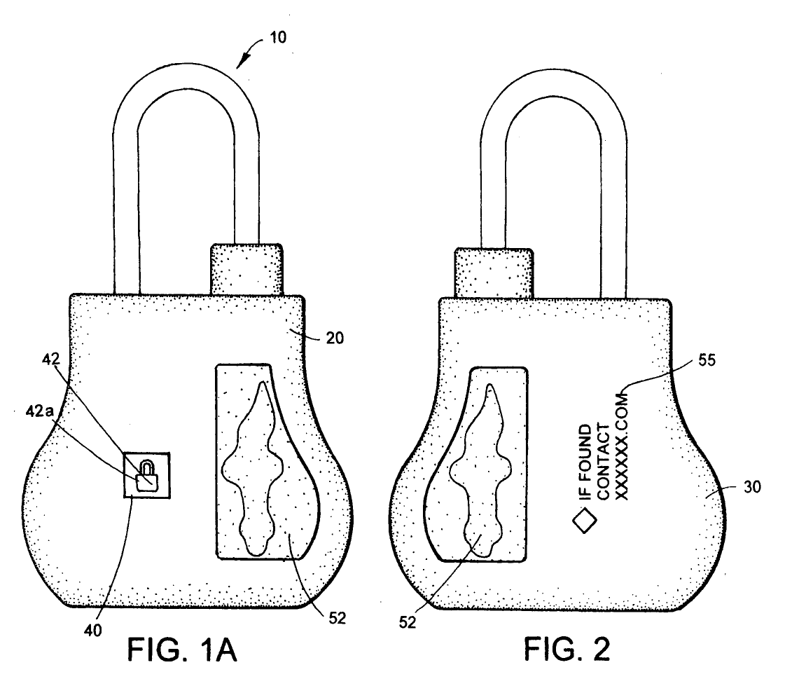

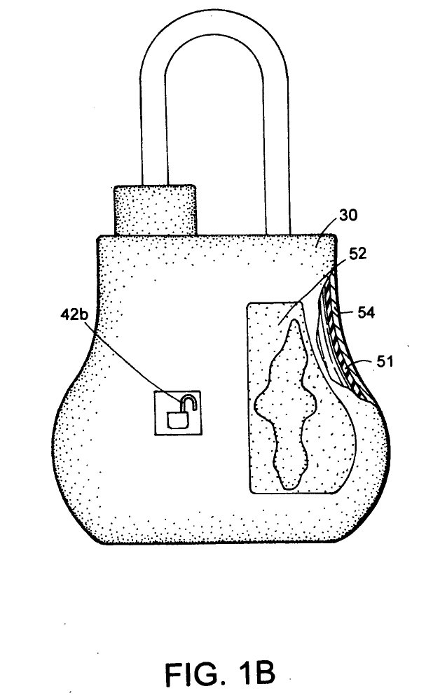

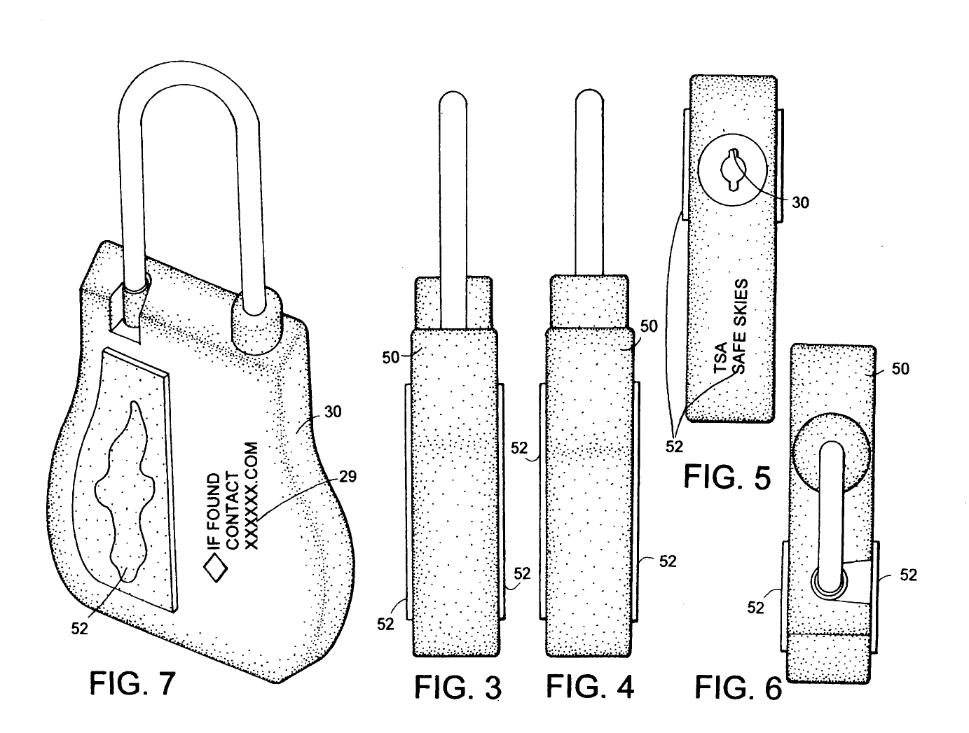

As seen from FIGS. 1-2, there is presented a special lock 10 for locking a piece of airline passenger luggage. Lock 10 may have a key mechanism 20 allowing it to be opened by a key held by the passenger and also allowing the special lock to be opened by a master key held by a luggage screening entity. Special lock 10 may be openable only by means of the key and/or master key and by no other means. For example, lock 10 may have no dial or combination mechanism nor any other mechanism (besides the key or master key) specifically designed to allow it to be opened, although it is certainly possible for someone to physically break into the lock 10 with massive force or use some other unlawful means to open the lock 10.

As seen from FIG. 2, special lock 10 may also include housing 30. Housing 30 has on a first side, which may be on a rear side thereof, a unique serial number of the special lock and may contain tracing information 29. Tracing information 29 may, for example, be a world wide web address 29 and/or telephone number of a tracing entity such as a company, so that a finder of the luggage can easily contact the tracing entity whose web address is listed on the lock from anywhere in the world where communications, i.e. telephone, internet, etc. are feasible. The tracing information 29 may also alert the passenger to check the binary display to ascertain whether the luggage screening entity opened the luggage and may be potentially responsible for any damage to the luggage and/or special lock.

As seen from FIGS. 1A and 1B, housing 30 may also have on a second side thereof, e.g. a front side thereof, a window 40 through which a display 42, e.g. a binary display, may be visible. The binary display may be a color binary display or any other readily visible designation of one of two states of being. For example, the binary display 42 may be of a first visible state 42b, for example, the color orange or a symbol of an unlocked lock, if the luggage screening entity has previously used the master key to open the luggage. Further, the binary display 42 may be of a second visible state 42a, for example the color green or the symbol of a locked lock, if the luggage screening entity has previously not used the master key to open the luggage. FIG. 1A and FIG. 1B show binary display 42 as being a symbol of a locked lock if the luggage screening entity did not open the luggage and as a symbol of an unlocked lock if the luggage screening entity did open the lock with the master key.

The special lock may also have, in accordance with U.S. Pat. Nos. 7,021,537 and 7,036,728 to Tropp incorporated herein by reference, identifying indicia other than the serial number alerting the luggage screening entity that the luggage screening entity has the master key and does not need to break into the luggage. The identifying indicia may also alert the luggage screening entity that the special lock is among those that the luggage screening entity has agreed to open to inspect contents of the luggage using the master key. Accordingly, the identifying indicia may be an indicia that was previously provided to the luggage screening entity and approved by the luggage screening entity to be used on these special locks to alert the luggage screeners of the luggage screening entity that the special lock is of the type that the luggage screening entity has the master key to and does not need to break the lock open to inspect the contents of the luggage. As seen in FIG. 1A, FIG. 1B, FIG. 2 and FIG. 7, identifying indicia 52 may be located directly on the front of special lock 10. As seen in FIG. 5, other identifying indicia 52 may in addition also be located on the bottom of lock 10.

If the passenger, after observing the unlocked lock symbol (see FIG. 1B) through the binary display window, understands that the luggage screening entity opened the luggage, then the passenger knows that the luggage screening entity is potentially responsible for any damage to the luggage and/or to the special lock. If, on the other hand, the passenger sees the symbol of a locked lock in the binary display window (see FIG. 1A), the passenger can rule out the luggage screening entity as being potentially responsible for damage to the luggage and focus greater attention on the airline or other entities as being potentially responsible.

As seen from FIG. 1B, housing 30 may comprise metal body 51 of special lock 10 encased in a coating 54 of a flexible material, such as rubber. Coating 54 may be thin so that the shape of the lock is not significantly altered while coating may be thick enough to prevent damage to lock after repeated collisions of lock 10 against a hard surface such as a wall.

The following experiment was conducted on metal luggage locks. In an experiment that was repeated a number of times, a metal luggage lock of the prior art was thrown against a hard wall ten times. The lock was examined. There were clear indications that the lock broke or was about to break. In addition, lock 10 of the present invention was thrown against the same wall ten times and no evidence of damage was detected.

In the event the luggage is lost (or even from normal wear and tear), the lock on the luggage may get banged considerably. The presence of rubber coating 54 over metal body 51 maximizes the chances that the special lock will remain attached to the luggage in good condition after the luggage is lost and at least until a time when the lost luggage is found by the finder and the finder has used the tracing information to contact the tracing entity.

As best seen from FIG. 1B, housing 30 may comprise a metal body 51 surrounded by a flexible rubber coating 54 that prevents special lock 10 from breaking even if special lock 10 collides on multiple occasions with a wall or other hard surfaces. Coating 54 may also keep special lock 10 attached to the luggage even if the luggage is lost since it is breakage of lock 10 that would most likely cause it to separate from the luggage to which it has been attached.

The rubber composition used for rubber coating 54 may have a thickness of approximately 30 um, which is approximately 0.03 millimeters. The rubber composition for coating 54 may incorporate various components. In one embodiment, the rubber composition may contain the following components at the following approximate percentages by volume of the whole composition: alkyd polyester (50%); springy powder (5%), dull enhancer (5%), tributyl ester (15%), ethyl ester (15%), diacetone alcohol (9%) and a drying agent or dessicant (1%).

The present invention may also be expressed as a method 100 of tracing lost airline luggage locked by a special lock 10 after the airline luggage has been checked and screened by a luggage screening entity. In this method 100, the special lock 10 has identifying indicia 52 alerting the luggage screening entity that the special lock is one that the luggage screening entity has the master key to and for which the luggage screening entity has agreed to use the master key rather than break into the luggage when inspecting contents of the luggage. The method 100 includes the step 110 of making available to consumers, for example by selling to them, the special lock 10 for use in locking individual pieces of an airline passenger's luggage. This special lock 10 includes a key mechanism 20 allowing the special lock 10 to be opened by a key held by the airline passenger and by a master key held by a luggage screening entity, the special lock having no other mechanism designed for opening the special lock.

The special lock 10 of method 100 may also have a housing 30 having metal body 51 surrounded by flexible coating 54 such as rubber, to prevent special lock 10 from breaking after multiple occasions with hard surfaces. Housing 30 may contain on a first side thereof a unique serial number of special lock 10 and may have tracing information 29 enabling a finder of the luggage to contact a tracing entity from anywhere in the world. “Anywhere in the world” means anywhere in the world that allows access to communications devices or systems such as telephones, satellites, computers having portals to the internet or world wide web, etc. allowing communicating internationally to be feasible. In addition, the housing 30 may have a window through which a binary display 42 is visible, the binary display changing from a first visible state 42a to a second visible state 42b when the luggage screening entity uses the master key to open the special lock, the binary display capable of being re-set from the second visible state to the first visible state when the key is used to open the special lock.

The method 100 may include the further step 120 of conveying to consumers the information that the special lock can be registered with the tracing entity. Registering the special lock 10 with the tracing entity enables the tracing entity to compile a list cross-referencing each unique serial number of a particular special lock with confidential contact information of an owner of the particular special lock. Step 120 also includes conveying to the consumers is the information that they can carry the luggage and check the luggage in without revealing passenger contact information to someone located at or near the luggage, including the airline personnel. Under this step 120 the information is conveyed to the consumer, for example on a package for the lock or on marketing material or advertising for the lock or for luggage that is sold with the lock, that the luggage, if lost, can be returned to the airline passenger using the tracing information and serial number in a manner that does not require the passenger to identify himself or herself. In addition, the information conveyed to consumers may include the fact that the finder may be offered a reward either through the tracing entity or through the passenger. For example, the reward may include a basic reward provided by the tracing entity applicable toward purchases of products and/or services of the tracing entity. In addition, the reward optionally may also include a monetary reward provided by the passenger. Upon return of the luggage the airline passenger can determine from the binary display whether the luggage screening entity opened the luggage is also conveyed to the consumers.

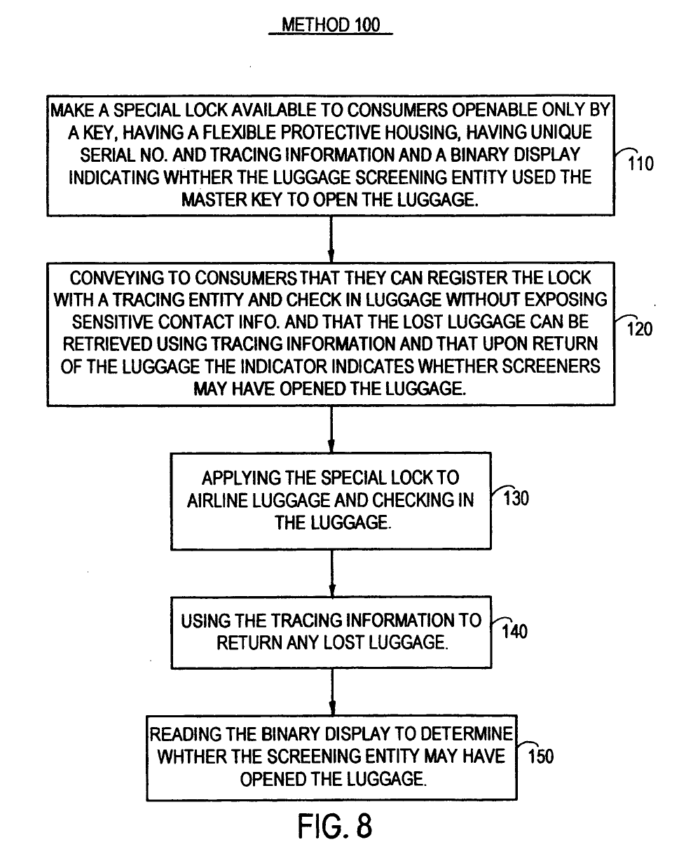

Further, as seen from FIG. 8, the method 100 may also include step 130 involving applying the special lock 10 to airline luggage and transmitting the luggage to an airline (i.e. checking the luggage in) so that the luggage can be screened by the luggage screening entity and, if necessary, opened using the master key.

A further step 140 of the method 100 may involve using the tracing information to return the luggage to the airline passenger after the luggage is lost. The method may also include a step 150 wherein the passenger reads the binary display 42 to determine whether the luggage screening entity opened the luggage and is potentially responsible for any damage to the luggage and/or special lock.

It should be understood, of course, that the foregoing relates to exemplary embodiments of the invention and that modifications may be made without departing from the spirit and scope of the invention as set forth in the following claims.

1. A special lock suitable for use in locking individual pieces of an airline passenger's luggage, comprising:
a key mechanism that allows the special lock to be opened by a key and by a master key, the special lock having no other mechanism designed for opening the special lock,
a housing of the special lock having on a first side thereof a unique serial number of the special lock and having tracing information enabling a finder of the luggage to contact a tracing entity from anywhere in the world, po1 the special lock having identifying indicia alerting the luggage screening entity that the luggage screening entity has the master key and does not need to break into the luggage,
the housing having on a second side thereof a window through which a display is visible, the display changing from a first visible state to a second visible state when the luggage screening entity uses the master key to open the special lock,
the display capable of being re-set from the second visible state to the first visible state when the key is used to open the special lock,
the housing comprising a metal body surrounded by a flexible rubber coating that prevents the special lock from breaking if the special lock collides on multiple occasions with hard surfaces.

2. The special lock of claim 1, wherein the identifying indicia also alerts the luggage screening entity that the special lock is among those that the luggage screening entity has agreed to open to inspect contents of the luggage using the master key.

3. The special lock of claim 1, wherein the tracing information alerts the passenger to check the display.

4. The special lock of claim 1, wherein the display cannot be re-set from the second visible state to the first visible state other than by the key.

5. The special lock of claim 1, wherein the display is a binary display.

6. A method of tracing lost airline luggage locked by a special lock after the airline luggage was checked and screened by a luggage screening entity, the method comprising:
making available to consumers the special lock for use in locking individual pieces of an airline passenger's luggage, the special lock having identifying indicia alerting the luggage screening entity that the special lock can be opened with a master key in the luggage screening entity's possession, rather than by breaking the lock, wherein the special lock includes a key mechanism allowing the special lock to be opened by a key held by the airline passenger and by a master key held by a luggage screening entity, the special lock having no other mechanism designed for opening the special lock,
the special lock having a housing comprising a metal body encased in a flexible coating that prevents the special lock from breaking if the special lock collides on multiple occasions with hard surfaces,
the housing containing on a first side thereof a unique serial number of the special lock and having tracing information enabling a finder of the luggage to contact a tracing entity from anywhere in the world,
the housing having a window through which a display is visible, the display changing from a first visible state to a second visible state when the luggage screening entity uses the master key to open the special lock, the display capable of being re-set from the second visible state to the first visible state when the key is used to open the special lock; and
conveying to consumers the information that
(i) the special lock can be registered with the tracing entity,
(ii) an airline passenger can carry and check in the luggage without revealing passenger contact information to someone located at or near the luggage; and that
(iii) the luggage, if lost, can be returned to the airline passenger using the tracing information and serial number and that upon return of the luggage the airline passenger can determine from the display whether the luggage screening entity opened the luggage.

7. The method of claim 6, wherein registering the special lock with the tracing entity enables the tracing entity to compile a list cross-referencing each unique serial number of a particular special lock with contact information of an owner of the particular special lock,

8. The method of claim 6, including conveying to consumers that a finder of the luggage, if lost, can use the tracing entity to return the luggage to the airline passenger without necessarily requiring identification of the airline passenger, and can obtain a reward.

9. The method of claim 8, wherein the reward includes a basic reward provided by the tracing entity applicable toward purchases of products and/or services of the tracing entity.

10. The method of claim 9, wherein the reward optionally also includes a monetary reward provided by the airline passenger.

11. The method of claim 6, wherein the display in the first visible state conveys an image of a locked lock and the display in the second visual state conveys an image of an unlocked lock.

12. The method of claim 6, wherein the window is on a second side of the housing.

13. The method of claim 6, wherein the tracing information alerts the passenger to check the display.

14. The method of claim 6, wherein the display is a binary display.

15. The method of claim 6, wherein the flexible coating is rubber.

16. A method of tracing lost airline luggage locked by a special lock after the airline luggage was checked and screened by a luggage screening entity, the method comprising:
making available to consumers the special lock for use in locking individual pieces of an airline passenger's luggage, the special lock having identifying indicia alerting the luggage screening entity that the special lock can be opened with a master key in the luggage screening entity's possession, rather than by breaking the lock, wherein the special lock includes a key mechanism allowing the special lock to be opened by a key held by the airline passenger and by a master key held by a luggage screening entity,
the special lock having a housing comprising a metal body encased in a flexible coating that prevents the special lock from breaking if the special lock collides on multiple occasions with hard surfaces,
the housing containing on a first side thereof a unique serial number of the special lock and having tracing information enabling a finder of the luggage to contact a tracing entity from anywhere in the world,
the housing having a window through which a binary display is visible, the binary display changing from a first visible state to a second visible state when the luggage screening entity uses the master key to open the special lock, the binary display capable of being re-set from the second visible state to the first visible state when the key is used to open the special lock; and
conveying to consumers the information that
(i) the special lock can be registered with the tracing entity,
(ii) an airline passenger can carry and check in the luggage without revealing passenger contact information to someone located at or near the luggage; and that
(iii) the luggage, if lost, can be returned to the airline passenger using the tracing information and serial number and that upon return of the luggage the airline passenger can determine from the binary display whether the luggage screening entity opened the luggage.

17. The method of claim 16, wherein the binary display in the first visible state conveys an image of a locked lock and the binary display in the second visual state conveys an image of an unlocked lock.

18. A method of tracing lost airline luggage locked by a special lock after the airline luggage was checked and screened by a luggage screening entity, the method comprising:
making available to consumers the special lock for use in locking individual pieces of an airline passenger's luggage, the special lock including a key mechanism allowing the special lock to be opened by a key held by the airline passenger and by a master key held by a luggage screening entity, the special lock having identifying indicia alerting the luggage screening entity that the special lock can be opened with a master key in the luggage screening entity's possession, rather than by breaking the lock, a housing of the special lock containing on a first side thereof a unique serial number of the special lock and the housing having tracing information enabling a finder of the luggage to contact a tracing entity from anywhere in the world; and
conveying to consumers the information
(i) that the special lock can be registered with the tracing entity,
(ii) that an airline passenger can carry and check in the luggage without revealing passenger contact information to someone located at or near the luggage; and
(iii) that the luggage, if lost, can be returned to the airline passenger using the tracing information and serial number.

19. The method of claim 18, further comprising conveying to consumers the information that upon return of the luggage the airline passenger can determine whether the luggage screening entity opened the luggage.

20. The method of claim 18, wherein other than the key mechanism and the master key, the special lock having no other mechanism designed for opening the special lock.

21. A method of tracing lost airline luggage after the airline luggage was checked and screened by a luggage screening entity, the method comprising:
making available to consumers a special lock for use in locking individual pieces of an airline passenger's luggage wherein the special lock includes a mechanism allowing the special lock to be opened, the special lock having a housing containing on a first side thereof a unique serial number of the special lock and having tracing information enabling a finder of the luggage to contact a tracing entity from anywhere in the world; and
conveying to consumers the information
(i) that the special lock can be registered with the tracing entity,
(ii) that an airline passenger can carry and check in the luggage without revealing passenger contact information to someone located at or near the luggage; and
(iii) that the luggage, if lost, can be returned to the airline passenger using the tracing information and serial number.

22. The method of claim 21, wherein the mechanism is a key mechanism that allows the special lock to be opened by a key and wherein other than the key mechanism the special lock has no other mechanism designed for opening the special lock.

23. A method of tracing lost airline luggage locked by a special lock after the airline luggage was checked and screened by a luggage screening entity, the method comprising:
making available to consumers the special lock for use in locking individual pieces of an airline passenger's luggage, the special lock having identifying indicia alerting the luggage screening entity that the special lock can be opened with a master key in the luggage screening entity's possession, rather than by breaking the lock, wherein the special lock is capable of being opened by the master key held by the luggage screening entity and is capable of being opened by another method, a housing of the special lock containing on a first side thereof a unique serial number of the special lock and the housing having tracing information enabling a finder of the luggage to contact a tracing entity from anywhere in the world; and
conveying to consumers the information
(i) that the special lock can be registered with the tracing entity,
(ii) that an airline passenger can carry and check in the luggage without revealing passenger contact information to someone located at or near the luggage; and that
(iii) that the luggage, if lost, can be returned to the airline passenger using the tracing information and serial number.
